(19) United States
(12) Patent Application Publication
(10) Pub. No.: US 2003/0064155 A1
(43) Pub. Date: Apr. 3, 2003

(54) Primer applying method

(76) Inventor: Takeshi Yamane, Oura-gun (JP)

Correspondence Address: MURAMATSU & ASSOCIATES, Suite 225, 7700 Irvine Center Drive, Irvine, CA, 92618, US

(21) Appl. No.: 10/261,360

(22) Filed: Sep. 30, 2002

(30) Foreign Application Priority Data
Oct. 2, 2001 (JP) 2001-306104

(51) Int. Cl. B05D 3/02; B05D 1/02

(52) U.S. Cl. 427/314; 427/421

(57) ABSTRACT

To provide a method of applying a primer in which film thickness of the primer is maintained constant to prevent pinholes, and a furnace is shortened as well. In a method of applying a primer to a back plate for a friction member, prior to applying the primer, the back plate is heated in advance. The temperature at which the back plate is preheated is set to be higher or equal to a temperature at which primer resin starts hardening within a range that the primer layer after hardening does not lose smoothness. When the primer is applied to the back plate preheated, the primer is immediately dried, and is hardened successively. At the preheating, even if the temperature is rapidly increased, a solvent for the primer does not bump, so that uniform film can be formed.

### BACKGROUND OF THE INVENTION

1. Field of the Invention

The present invention relates to friction members such as brakes and clutches, and more particularly, to a method of applying a primer to a back plate of the friction member.

2. Description of the Related Art

Friction members such as pads for disk brakes, brake shoes and clutch facings are formed by attaching a friction material to a back plate made of ferrous material.

Relative movement added to the friction member pressed with a disk rotor or an opposing clutch plate, and frictional force generated at that moment causes an automobile to be stopped or to be transmitted driving force of an engine to wheels. As a result, considerably large shearing force is generated between the friction material and the back plate. Therefore, strong adhesive force between the friction material and the back plate to bear the shearing force has been required.

FIG. 3 is a flow chart showing a method of manufacturing a friction member using a conventional primer applying method. At first, a steel plate as a material is punched out through pressing to form a back plate (#100). A large amount of oil for rust prevention or lubrication is adhered to the work punched out as described above. The oil may reduce adhesive force when a friction material is attached, so that it is washed out with water containing several percent of alkali degreasing agent (#102).

Then, grinding particles are blasted in a sandblasting process to remove oxide films and burrs at pressing, and the surface of the work is made rough until arithmetical mean deviation of the profile becomes approximately several micrometers (#104), which allows adhesive area to be increased to improve adhesive strength. In addition, since rust or oxide films on the adhesive face may reduce the adhesive force, the rust and oxide films are removed in the sandblasting process when the face is made rough.

It is also possible to simultaneously perform the degreasing and sandblasting by adding alkali degreasing agent to slurry in a wet sandblasting process.

The back plate, which is made rough, and form which rust, oxide films and the like thereon are removed in the above-mentioned process, is coated with a film such as zinc phosphate with the thickness of 3 to 5 μm on the surface thereof (#106). This film functions together with a primer layer described below to prevent rust. The film is inorganic and the primer layer is organic, so that they cooperate to improve effect on rust prevention.

In order to form a primer layer on the surface of the back plate, firstly, liquid phenol resin diluted with alcohol is applied to the back plate (#108) since the viscosity of phenol resin itself is high, and it is difficult to apply the phenol resin itself on the surface.

Next, the back plate with the primer is fed to a furnace for drying and baking (#110). Heat in the furnace allows the temperature of the dilution liquid to be the boiling point of alcohol, so that alcohol volatizes. Continuous heating allows the temperature of the phenol resin to be hardening temperature thereof to harden the phenol resin.

After that, a friction material is attached to the back plate at the adhered side, and the resultant is painted to be friction member (#114). In the above processes from degreasing and washing process (#102) to the bonding and drying process (#112), the back plate is introduced to each process while it is mounted on a conveyor. However, temperature increase in the primer drying process should be slow since rapid temperature increase of the back plate may cause bumping of the solvent, so that bubbles may be generated in the primer layer or craters may be formed. As a result, there is a fear that the thickness of the primer layer may fluctuate. Further, pinholes may be formed in the film of the primer, and rust is generated there, which may be spread beneath the primer layer.

As described above, the drying and baking of the primer are performed while the back plate is transported on a belt conveyor in a furnace. Therefore, it is necessary to lengthen the furnace to gradually increase the temperature, resulting in an unpreferable large-scale system.

### SUMMARY OF THE INVENTION

The present invention has been made to solve the above problems and to provide a method of applying a primer in which not only film thickness of the primer is maintained constant to prevent pinholes but also a furnace is shortened.

To accomplish the above objective, a method of applying a primer according to the present invention is characterized in that the method comprises the steps of preheating a back plate for a friction member; applying a primer to the back plate preheated; and drying and hardening the primer applied.

In the above method, a temperature at which the back plate is preheated may be higher than boiling point of a solvent containing the primer; a temperature at which the back plate is preheated can be higher than a temperature at which primer resin starts hardening; the primer resin may be phenol resin and the temperature at which the back plate is preheated can be from 313K to 573K or from 393K to 523K; the preheating of the back plate is to be performed by one of induction heating, dielectric heating and infrared heating; the preheating of the back plate, the applying of the primer and the drying and hardening of the primer can be preformed while the back plate is mounted on a conveyor; and the applying of the primer may be performed with plurality of sprays in multiple stages.

### BRIEF DESCRIPTION OF THE DRAWINGS

The present invention will be more apparent from the ensuring description with reference to the accompanying drawings wherein:

FIGS. 1 is a flow chart showing a friction member manufacturing method using a primer applying method according to the present invention;

FIG. 2 is a drawing for explaining embodiments 1 to 9 according to the present invention and comparative examples 1 and 2; and

FIGS. 3 is a flow chart showing a friction member manufacturing method using a conventional primer applying method.

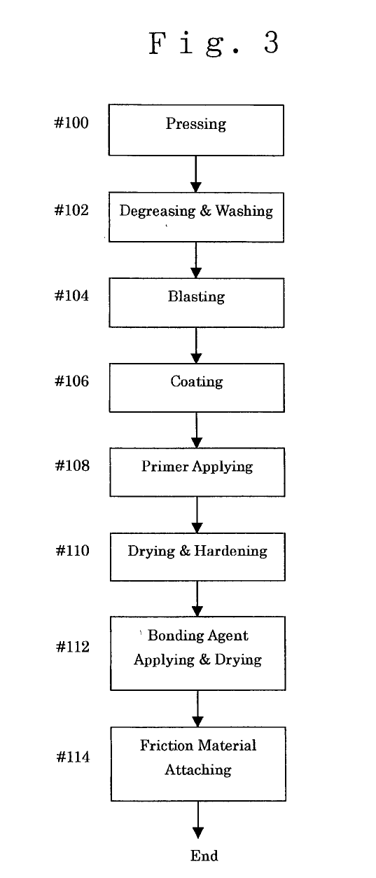

### DETAILED DESCRIPTION OF PREFERRED EMBODIMENTS

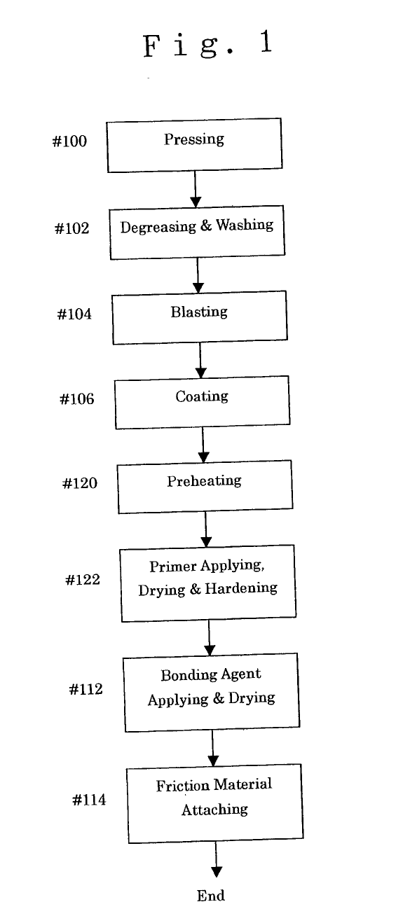

In FIG. 1, processes from pressing (#100) to coating (#106) are the same as described above in the description of a conventional method. After the film is formed, the back plate is heated in advance (hereinafter referred to as “preheated”) in #120. The temperature for preheating is approximately 313K at the lowest, at which the vaporization of lower alcohol as a solvent is accelerated. And, the temperature for preheating is approximately 573K at the highest, which is the upper limit to prevent the resin from being baked and starting deterioration. However, the temperature is preferably higher or equal to 333K, which is near the boiling point 353 of lower alcohol, and is approximately 553K, which is higher than the temperature 393K to 493K at which the resin hardens, and is more preferably within the range between 393K at which the primer resin starts hardening and 523K that is the limit the hardened primer maintains smoothness. At this preheating, it is unnecessary to gradually increase the temperature for preheating, and the temperature can be increased rapidly.

Methods for preheating are not especially restricted. For instance, induction heating utilizing high frequency waves, dielectric heating, microwave heating utilizing microwave, and near- and far-infrared heatings utilizing light and furnaces utilizing electricity and gas can be used. It is reasonable to adopt induction heating, heating with light or air-heating furnace since the back plate is metal. In consideration that the length of the furnace can be shortened, induction heating and heating with light are much preferable. In the heating with light, light, of which wave length is between 1 to 3.5 μm in a near- to far-infrared range at its peak of light emission, is usable, however, energy efficiency and power density (W/cm²) of light are higher as wave length of the light is shorter, so that a middle- or near-infrared ray is preferable. For the coated plate, light, of which wave length is between 1 to 3.5 μm at its peak of light emission, which coincides with its absorption peak, is much preferable.

A primer is applied to the back plate preheated as described above. (#122). Diluting liquid phenol resin with alcohol as described above makes the primer. The alcohol as solvent is a lower alcohol of which boiling point is about 353K.

The primer is applied through a spray while a work is mounted on a conveyor or a tray. In this case, plurality of spray guns is preferably used since not only the surface of the back plate but also sides face and inner faces of holes drilled on the back plate should be covered. The application of the primer is also preferably performed in multiple stages.

In ordinary heating after the application of the primer, heat is transmitted from outside of the film applied, so that viscosity increases, and the film is dried and hardened from outside of the film. As a result, the film will harden with bubbles sealed up therein, or when heated rapidly the primer bumps to generate craters and pinholes, which is not preferable since the thickness of the film fluctuates. On the contrary, in the present invention, the back plated is heated in advance, and the primer is applied in multiple stages, therefore, when the primer is applied, lower alcohol as a solvent simultaneously and instantly evaporates and is dried, so that it is preferable that bubbles that do not remain in the primer.

If the preheating temperature is higher than boiling point of the solvent, the primer is rapidly dried after applied. Gases, generated when the solvent evaporates, are treated in a scrubber in an application booth, which eliminates gas treatment in the next process.

When the preheating temperature is between 393K and 523K, in the same manner as described above, after drying the primer, the back plate is heated to maintain it at a temperature higher than its hardening temperature in baking process. When the temperature in the baking process is between 403K and 523K, the condition is maintained for 20 seconds to 2 minutes to harden the resin. When the preheating temperature is higher or equal to 523K, the hardening process can be eliminated. In any case, when the resin is hardened, the primer is already dried, so that rapid increase of temperature does not cause problems such as bumping of the solvent.

After that, bonding agent to the back plate is applied and is dried (#112), then a friction material is attached to the back plate (#114). Finally, the back plate becomes a friction member through finish painting and the like.

[Embodiments]

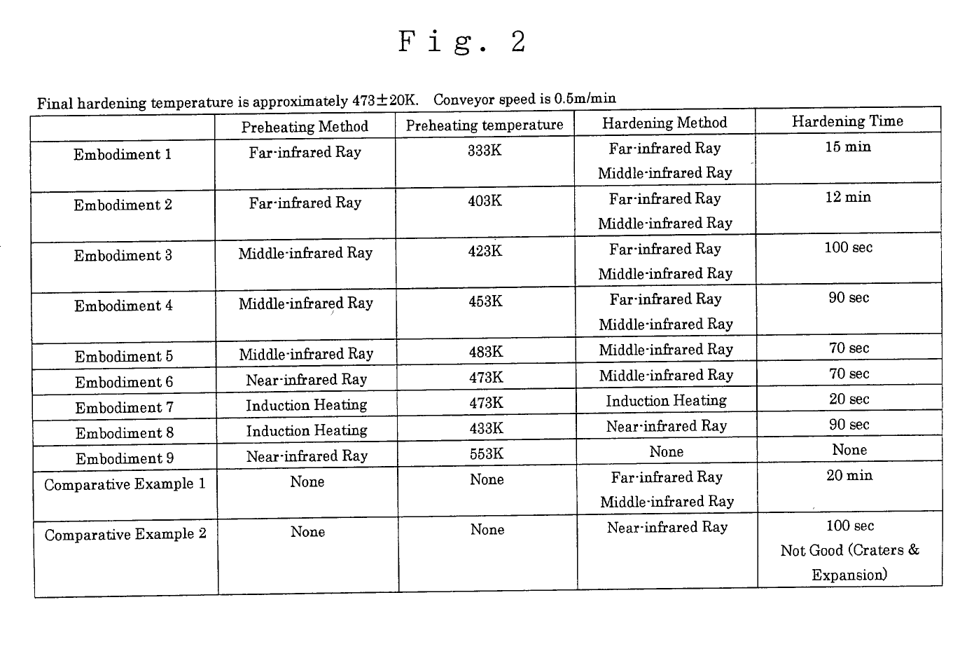

Embodiments of the present invention will be explained below with reference to FIG. 2. In the all embodiments, the velocity of conveyors is 0.5 m/min and the final hardening temperatures of primer resins are 473K±20K.

In embodiment 1, a back plate after coating process was preheated with a far-infrared ray (of which wave length is 3.7 μm) up to 333K, and a primer was applied. The preheating was rapidly preformed. The primer was applied in multiple stages with plurality of spray guns. At the above temperature 333K, only alcohol as a solvent vaporized, and the primer was dried, but it was not hardened. In order to harden (bake) the primer layer, infrared rays, which were far- and middle-infrared rays with 2.5 to 3.7 μm of wave length, were radiated to increase the temperature up to 473K±20K, and the primer applied back plate was maintained 15 minutes in the condition, which allowed the primer layer to be hardened (baked). In the embodiment 1, since the preheating temperature is much lower than the hardening temperature of the resin, it took long time for the hardening. However, the temperature increase at the hardening could be rapid, which shortened the time for the application.

In embodiment 2, the same back plate as the embodiment 1 was preheated with a far-infrared ray (of which wave length is 3.7 μm) up to 403K and a primer was applied to the plate. Heating velocity and method of applying the primer were the same as the embodiment 1. The temperature 403K is higher than boiling point 353K of the solvent, so that drying was rapidly performed, but the temperature is lower than 413K that is the temperature at which the primer layer starts hardening, so that the primer layer was not hardened. In order to harden the primer layer, lights from far- to middle-infrared rays (of which wave length is between 2.5 and 3.7 μm) were emitted to increase the temperature up to 473K±20K, and the condition is maintained for 12 minutes to harden the primer layer. In the embodiment 2, the preheating temperature is higher than the boiling point of the solvent, but is lower than the hardening point of the resin, so that drying was rapidly performed but it took considerably long time to harden the resin in the same manner as the embodiment 1.

In embodiment 3, a back plate was preheated by radiating a middle-infrared ray (of which wave length is 2.5) up to 423K, and then a primer was applied. Since this temperature is slightly higher than the temperature (413K) at which the resin starts hardening, it is considered that the primer was dried and its hardening proceeded immediately after applied. Because of this, after the primer was applied, far- and middle-infrared rays (of which wave length is between 2.5 to 3.7 μm) were emitted, and the temperature was increased up to 473±20K to harden the primer layer, which caused the primer to be hardened for 100 seconds.

In embodiment 4, with a middle-infrared ray (of which wave length is 2.5 μm), a back plate was preheated up to 453K, and then a primer was applied. This temperature is remarkably higher than the temperature (413K) at which the resin starts hardening, so that the hardening of the primer proceeded considerably. After the primer was applied, far- and middle-infrared rays (of which wave length is between 2.5 to 3.7 μm) were emitted, and the temperature was increased up to 473±20K to harden the primer layer, which caused the primer to be hardened for 90 seconds.

In embodiment 5, with a middle-infrared ray (of which wave length is 2.5 μm), a back plate was preheated up to 483K, and then a primer was applied. This temperature is remarkably higher than the temperature (413K) at which the resin starts hardening, so that the primer was dried immediately after applied, and hardening of the primer also proceeded considerably. In the process for hardening the primer after the application, a middle-infrared ray (of which wave length is 2.5 μm) was used to heat the primer layer, which caused the primer to be hardened for 70 seconds at 473±20K.

In embodiment 6, with a near-infrared ray (of which wave length is 1.2 μm), a back plate was preheated up to 473K, and then a primer was applied. This temperature is remarkably higher than the temperature (413K) at which the resin starts hardening, but sufficiently lower than the upper limit 573K, therefore hardening of the primer proceeded considerably. In the process for hardening the primer after the application, a middle-infrared (of which wave length is 2.5 μm) was used to heat the primer, and the primer layer was hardened for 70 seconds at 473K±20K.

In embodiment 7, with induction heating, a back plate was preheated up to 473K, and then a primer was applied. This temperature is remarkably higher than the temperature (413K) at which the resin starts hardening, so that the primer was dried immediately applied, and the hardening of the primer proceeded considerably. In the process for hardening the primer after the application also, induction heating was used to heat the primer, and the primer layer, was hardened for only 20 seconds at 473K±20K.

In embodiment 8, with induction heating, a back plate was preheated up to 433K, and then a primer was applied. This temperature is higher than the temperature (413K) at which the resin starts hardening, so that the primer was dried immediately after applied, and the hardening of the primer proceeded considerably. In the process for hardening the primer after the application, a near-infrared ray (of which wave length is 1.2 μm) was used to heat the primer layer, which caused the primer to be hardened for 90 seconds at 473K±20K.

As shown in the embodiments 1 to 8, generally, when the preheating temperature is set to be higher than the temperature (413K) at which the resin starts hardening, the time for hardening is to be shortened. In addition, as noted from the embodiments 3 to 8, there was a difference of 100 seconds to 20 seconds in hardening time, which was rather small in comparison to the embodiments 1 and 2, therefore, it may be possible to say baking process was performed for substantially the same period of time.

Since the back plate is transported via belt conveyors, the embodiments 3 to 8, show that the length of the belt conveyor in hardening process can considerably be shortened.

In embodiment 9, with a near-infrared ray (of which wave length is 1.2 μm), a back plate was preheated up to 553K, and then a primer was applied, which causes the primer layer to be hardened in a short period of time after applied, resulting in no hardening process for the primer. Generally, when the preheating temperature becomes higher or equal to 523K, it becomes unnecessary to independently provide a process to harden the resin. However, when the temperature exceeds 523K, the smoothness of the face on which the primer is applied is spoiled, so that the temperature should be lower or equal to 523K if the smoothness is desired.

In comparative example 1, a back plate was not preheated, that is, conventional method was adopted. To the back plate with a coating was applied the primer at a normal temperature, and the temperature was gradually increased up to 473±20K at which the resin starts hardening. The gradual increase of temperature allowed boiling and bubbles not to be generated when the primer was dried, and a beautiful face of the primer was obtained and the face was hardened, however, it took 20 minutes, which was a very long time. This means that the length of conveyors in drying and baking process after the primer is applied becomes long, resulting in a large-scale system.

In comparative example 2, a back plate was not preheated, and the primer was forcibly dried and baked for 100 seconds to shorten the length of the conveyors. The back plate after the primer was applied was rapidly heated up to 473±20K, so that the solvent was bumped and craters and bubbles were generated on the faces that the primer was applied.

As described above, in the method for applying primer to a back plate for a friction member according to the present invention, prior to the primer application process, the back plate is preheated, so that the application of the primer is adequately carried out, which shortens the time that the primer is applied.

When the preheating temperature is set to be higher or equal to the temperature at which the primer resin starts hardening, the primer is dried immediately after applied, and then it is hardened successively, therefore, the time for application, drying and hardening of the primer is to be shortened. In this case, induction heating or infrared heating can be selected to perform the preheating, which simplifies the construction of the system.

When the preheating of the back plate, the application of the primer, the drying and hardening of the primer are performed while the back plate is mounted on belt conveyors, the length of the system can be shortened.

What is claimed is:

1. A method of applying a primer comprising the steps of:
preheating a back plate for a friction member;
applying a primer to said back plate preheated; and
drying and hardening said primer applied.

2. The method of applying a primer as claimed in claim 1,
wherein a temperature at which the back plate is preheated is higher than boiling point of a solvent containing said primer.

3. The method of applying a primer as claimed in claim 1,
wherein a temperature at which the back plate is preheated is higher than a temperature at which primer resin starts hardening.

4. The method of applying a primer as claimed in claim 1,
wherein said primer resin is phenol resin and said temperature at which the back plate is preheated is from 313K to 573K.

5. The method of applying a primer as claimed in claim 1,
wherein said primer resin is phenol resin and said temperature at which the back plate is preheated is from 393K to 523K.

6. The method of applying a primer as claimed in claim 1,
wherein said preheating of the back plate is performed by one of induction heating, dielectric heating and infrared heating.

7. The method of applying a primer as claimed in claim 1,
wherein said preheating of the back plate, said applying of the primer and said drying and hardening of the primer are preformed while said back plate is mounted on a conveyor.

8. The method of applying a primer as claimed in claim 1,
wherein said applying of the primer is performed with plurality of sprays in multiple stages.
